(19) United States
(12) Patent Application Publication
(10) Pub. No.: US 2020/0005731 A1
(43) Pub. Date: Jan. 2, 2020

(54) BACKLIGHT ADJUSTMENT METHOD, DEVICE, SYSTEM, HEAD-UP DISPLAY AND STORAGE MEDIUM

(71) Applicant: BOE TECHNOLOGY GROUP CO., LTD., Beijing (CN)

(72) Inventors: Fan YANG, Beijing (CN); Xitong MA, Beijing (CN); Xin WANG, Beijing (CN); Xuelin HAN, Beijing (CN)

(73) Assignee: BOE TECHNOLOGY GROUP CO., LTD., Beijing (CN)

(21) Appl. No.: 16/460,123

(22) Filed: Jul. 2, 2019

(30) Foreign Application Priority Data
Jul. 2, 2018 (CN) 201810709626.8

(51) Int. Cl. G09G 5/10; G02B 27/01

(52) U.S. Cl. CPC G09G 5/10; G02B 27/0101; G09G 2320/0646; G02B 2027/0138; G02B 2027/0118; G09G 2360/16; G09G 2320/0233

(57) ABSTRACT

A method, a device, a system for adjusting backlight, a HUD, and a storage medium are provided. The method includes: acquiring an image projected by the HUD onto a target region; dividing the image into image regions, and acquiring a brightness value of each image region; determining a brightness adjustment value of each image region according to the brightness value and a target brightness value of the each image region; according to the brightness adjustment value of the each image region, generating a brightness adjustment signal to be applied to light sources of a backlight region corresponding to the each image region in the HUD, so as to adjust brightness of the each image region to reach the target brightness value.

### CROSS-REFERENCE TO RELATED APPLICATION

This application claims priority to Chinese Patent Application No. 201810709626.8 filed on Jul. 2, 2018, which is incorporated herein by reference in its entirety.

### TECHNICAL FIELD

The present disclosure relates to the field of display technology, and in particular, to a method for adjusting backlight, a device for adjusting backlight, a Head-Up Display, a system for adjusting backlight, and a computer readable storage medium.

### BACKGROUND

A Head-Up Display (HUD) may be used in vehicles. The Head-Up Display mainly includes a display and an optical projection unit. An image displayed by the display may be projected onto a windshield of a vehicle through the optical projection unit. When a driver of the vehicle drives the vehicle, the image projected on the windshield may be directly observed by the driver without bowing his head, and thus attention of the driver may not be interrupted and a driving safety may be increased. The image typically includes information related to driving the vehicle, such as a current speed, vehicle navigation information, driving assistance information (e.g., current road conditions, a vehicle fuel level, a tire pressure), and the like.

### SUMMARY

A method for adjusting backlight, a device for adjusting backlight, a Head-Up Display, and a system for adjusting backlight are provided in the present disclosure.

In a first aspect, a method for adjusting backlight is provided in the present disclosure. The method is applied to a Head-Up Display and includes: acquiring an image projected by the Head-Up Display onto a target region; dividing the image into a plurality of image regions, and acquiring a brightness value of each image region of the plurality of image regions; determining a brightness adjustment value of the each image region according to the brightness value of the each image region of the plurality of image regions and a target brightness value of the each image region; according to the brightness adjustment value of the each image region, generating a brightness adjustment signal to be applied to one or more light sources of a backlight region corresponding to the each image region in the Head-Up Display, so as to adjust brightness of the each image region to reach the target brightness value.

Optionally, the target brightness value is determined by: using a preset brightness value as the target brightness value; or using, as the target brightness value, an average brightness value calculated based on brightness values of the plurality of image regions; or using a brightness value of one image region of the plurality of image regions as the target brightness value.

Optionally, the image is a white image, the plurality of image regions are M*N regions divided along a horizontal direction and a vertical direction of the image, and M and N are positive integers.

Optionally, in a case that the average brightness value calculated based on the brightness values of the plurality of image regions is used as the target brightness value, the average brightness value is a sum of the brightness values of the plurality of image regions divided by a total number of the plurality of image regions; in a case that the brightness value of the one image region of the plurality of image regions is used as the target brightness value, the one image region is an image region located at a center position of the image.

In a second aspect, a device for adjusting backlight is provided in the present disclosure. The device is applied to a Head-Up Display and includes an image acquisition circuit, configured to acquire an image projected by the Head-Up Display onto a target region; an image-region brightness-value determination circuit, configured to divide the image into a plurality of image regions, and acquire a brightness value of each image region of the plurality of image regions; a brightness adjustment value determination circuit, configured to determine a brightness adjustment value of the each image region of the plurality of image regions according to the brightness value and a target brightness value of the each image region; a brightness adjustment signal generation circuit, configured to generate, according to the brightness adjustment value of the each image region, a brightness adjustment signal to be applied to one or more light sources of a backlight region corresponding to the each image region in the Head-Up Display, such that the brightness value of the each image region reaches the target brightness value.

Optionally, the target brightness value is determined by: using a preset brightness value as the target brightness value; or using, as the target brightness value, an average brightness value calculated based on brightness values of the plurality of image regions; or using a brightness value of one image region of the plurality of image regions as the target brightness value.

Optionally, the image is a white image, the plurality of image regions are M*N regions divided along a horizontal direction and a vertical direction of the image, and M and N are positive integers.

Optionally, in a case that the average brightness value calculated based on the brightness values of the plurality of image regions is used as the target brightness value, the average brightness value is a sum of the brightness values of the plurality of image regions divided by a total number of the plurality of image regions; in a case that the brightness value of one image region of the plurality of image regions is used as the target brightness value, the one image region is an image region located at a center position of the image.

In a third aspect, a device for adjusting backlight is provided in the present disclosure. The device is applied to a Head-Up Display and includes a processor; a storage, coupled to the processor via a bus and including computer programs stored on the storage, wherein, when the processor executes the computer programs, the processor implements the method for adjusting backlight according to the first aspect.

In a fourth aspect, a Head-Up Display is provided in the present disclosure. The Head-Up Display includes a display screen, including a backlight source including a plurality of backlight regions, wherein each of the plurality of backlight regions includes one or more light sources; an optical projection unit, configured to project an image displayed by the display screen to a target region; and the device for adjusting backlight according to the second aspect, wherein, the device for adjusting backlight adjusts brightness of the one or more light sources of each backlight region of the plurality of backlight regions according to the brightness adjustment signal.

Optionally, the backlight source is a direct-lit type backlight source.

Optionally, the display screen displays one frame of the image for every preset time period.

In a fifth aspect, a system for adjusting backlight is provided in the present disclosure. The system includes the Head-Up Display according to the fourth aspect; and a camera, configured to face the target region and acquire the image projected to the target region and transmit the captured image to the Head-Up Display.

In a sixth aspect, a non-transitory computer readable storage medium is provided in the present disclosure, and includes computer programs stored on the non-transitory computer readable storage medium, wherein when the computer programs are executed by a processor, the processor implements steps of the method according to the first aspect.

### BRIEF DESCRIPTION OF THE DRAWINGS

Accompanying drawings herein are incorporated into the specification and form a part of the specification, illustrate embodiments consistent with the present disclosure, and are used to explain principles of the present disclosure together with the specification.

FIG. 1 is a flowchart of a method for adjusting backlight according to the present disclosure;

FIG. 2 is a schematic diagram of dividing an image into a plurality of image regions according to the present disclosure;

FIG. 3 is a schematic structural diagram of a device for adjusting backlight according to the present disclosure;

FIG. 4 is another schematic structural diagram of a device for adjusting backlight according to the present disclosure;

FIG. 5 is a schematic structural diagram of a system for adjusting backlight according to the present disclosure.

### DETAILED DESCRIPTION

Exemplary embodiments will be described in detail herein. Examples of the exemplary embodiments are shown in the drawings. When the following description refers to the drawings, same reference signs in different drawings represent same or similar units unless otherwise indicated. The embodiments described in the following exemplary embodiments do not represent all embodiments of the present disclosure. Instead, they are merely examples of devices and methods consistent with aspects of the present disclosure and described in detail in the claims. It should be understood that the detailed description of the present disclosure is only illustrative and explanatory, but does not limit the present disclosure.

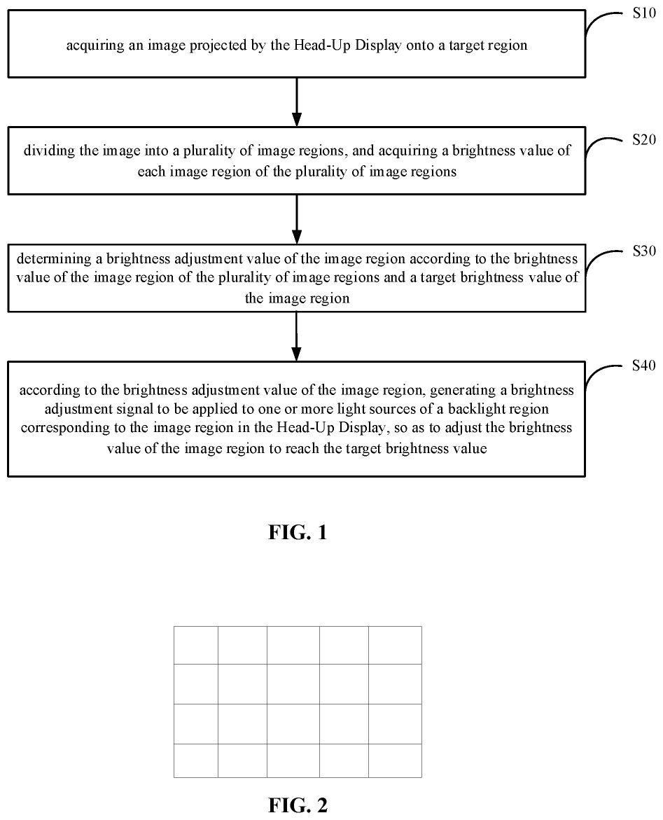

When the Head-Up Display projects an image to be displayed onto the windshield, external light rays illuminate and pass through the windshield. Since the windshield usually has a certain inclination angle, light intensities of the external light rays transmitted through the windshield at various positions of the windshield are not uniformly distributed, and thus brightness values of different portions of the image projected on the windshield are non-uniform. Since different portions of the image projected onto the windshield of the Head-Up Display have non-uniform brightness values, some embodiments of the present disclosure provide a method for adjusting backlight, and this method is applied to a Head-Up Display. As shown in FIG. 1, the method includes steps S10-S40.

Step S10: acquiring an image projected by the Head-Up Display onto a target region.

Step S20: dividing the image into a plurality of image regions, and acquiring a brightness value of each image region of the plurality of image regions.

Step S30: determining a brightness adjustment value of the image region according to the brightness value of the image region of the plurality of image regions and a target brightness value of the image region;

Step S40: according to the brightness adjustment value of the image region, generating a brightness adjustment signal to be applied to one or more light sources of a backlight region corresponding to the image region in the Head-Up Display, so as to adjust the brightness value of the image region to reach the target brightness value.

The Head-Up Display mainly includes a display screen and an optical projection unit, and the image displayed on the display screen may be projected to the target region through the optical projection unit, and the target region is related to a scene to which the Head-Up Display is applied. For example, when the Head-Up Display is applied to a vehicle, the image may be projected onto a windshield of the vehicle; or the Head-Up Display may also be applied to an aircraft, and the image displayed by the display may be projected onto a windshield of the aircraft. In both scenes, a region of the windshield onto which the image is projected is the target region. The image projected onto the target region by the Head-Up Display may have a preset color, such as may be a green image, a red image or a blue image, etc. and, optionally may be a white image.

In a process of projecting, by the optical projection unit, an image displayed on the display screen, part of brightness of the image may be lost. In order to ensure the brightness and a display effect of the image projected onto the target region, the display screen usually adopts a liquid crystal display with a higher brightness value.

A driver may observe the image projected onto the target region by the Head-Up Display, for example, the image projected onto the windshield of the vehicle. Since the windshield is transparent, the driver may also watch physical objects on a road through the windshield. Therefore, the driver does not need to bow his head to directly observe the image projected onto the windshield, and does not affect the driver from observing the physical objects on the road.

The image projected by the Head-Up Display onto the target region includes information related to the scene to which the Head-Up Display is applied. For example, in a case of the Head-Up Display being applied to a vehicle, the image typically includes information related to driving the vehicle, such as a current vehicle speed, vehicle navigation information, driving assistance information (e.g., a current road condition, vehicle fuel level, a tire pressure), and the like.

In order to prevent non-uniform brightness of the projected image on the windshield due to the intensity of external light, the display in the present disclosure may be controlled to display an image of a preset color, the image of the preset color may be an image of a single color, for example, a green image, a red image, or a blue image, etc., optionally a white image. When the white image displayed by the display is projected onto a target region (for example, the windshield), a brightness value of the white image may be relatively accurately determined by acquiring the projected white image.

The image projected by the Head-Up Display may be acquired by a camera (such as a video camera or a camera head). The camera may face the target region, and the image projected to the target region may be acquired by the camera. For example, for a case in which the Head-Up Display is applied to the vehicle, the camera may be disposed at a position facing the windshield in the vehicle to capture an image projected onto the windshield by the camera. The camera may communicate with the Head-Up Display by a wired communication and/or a wireless communication and is configured to transmit to the Head-Up Display the captured image projected to the target region. A specific manner of the wired communication and the wireless communication may be any manner known to those skilled in the art. The present disclosure does not describe the manner in detail.

The image is divided into a plurality of image regions, for example, the image is divided into M rows in a horizontal direction and N columns in a vertical direction to obtain M*N image regions, as shown in FIG. 2, where M and N are positive integers. For example, FIG. 2 shows a division of the image into 4*5 image regions.

When the image projected to the target region is captured by the camera, since the image is projected on the target region, and the external light is also irradiated on the target region, the brightness of the image captured by the camera and projected to the target region includes the brightness of the image itself displayed by the display of the Head-Up Display, and the brightness of the external light distributed on the image when the external light illuminates onto the target region to which the image is projected.

After the image is divided into the plurality of image regions, brightness values of the image regions may be separately obtained. If a light-intensity distribution of the external light illuminated at various positions on the image is non-uniform, the brightness value of each of the image regions may be different from that of another of the image regions, and the brightness adjustment value applied to each image region of the image regions is further obtained according to the brightness value of the image region and the target brightness value of the image region. Specifically, the difference between the brightness value of each image region and the target brightness value of the image region may be compared, and a difference obtained through the comparison is used as the brightness adjustment value.

The brightness adjustment signal is generated according to the brightness adjustment value of each image region, and the brightness adjustment signal is applied to one or more light sources of the backlight region corresponding to the image region, and the one or more light sources of the backlight region corresponding to the image region may be adjusted based on the brightness adjustment signal, such as increasing light-emitting brightness or reducing light-emitting brightness.

When the brightness of the backlight source of the Head-Up Display (that is, the backlight source of the display) is changed, the brightness value of the image displayed on the display is also changed. Therefore, the backlight may be divided into a plurality of backlight regions, and each of the backlight regions usually includes one or more light sources, and each of the backlight regions is in a one-to-one correspondence with one of the image regions, that is, the one or more light sources of each backlight region provide backlighting for an image region located in a light-exiting direction of the backlight region. The light-emitting brightness of the one or more light sources of each backlight region is adjusted under a control of the brightness adjustment signal. When the brightness of the one or more light sources of the backlight region corresponding to each image region is adjusted, the brightness value of the image region is also adjusted accordingly. Therefore, by adjusting the brightness of the one or more light sources in the backlight region, the brightness value of each image region may be made to reach the target brightness value.

As may be seen from the above description, the method for adjusting backlight may adjust the brightness value of each of the image regions to the target brightness value by adjusting the brightness of the one or more light sources in the backlight region corresponding to the image region, so that the brightness value of the image region may reach the target brightness value. When the Head-Up Display projects the displayed image onto the target region, the brightness values of the image regions of the image are uniform, brightness value uniformity of the image is not affected by the external light, and display uniformity of the image projected onto the target region is improved.

In an optional embodiment, the target brightness value may be determined by using a preset brightness value as the target brightness value, or by using, as the target brightness value, an average brightness value calculated based on the brightness values of all image regions, or by using the brightness value of one image region of the image regions as the target brightness value.

The target brightness value is a brightness value to be reached for each image region after adjusting an initial brightness value of the image region. The target brightness value may be a preset brightness value configured in advance as required; or the target brightness value may be, after the brightness value of each image region is determined, the average brightness value calculated based on the brightness value of all image regions may be used as the target brightness value, and the average brightness value is, for example, a sum of brightness values of all image regions divided by a total number of image regions; or a brightness value of one image region selected from all image regions is taken as the target brightness value, and the selected image region may be any one of the plurality of image regions, for example, a brightness value of an image region located at center position is used as the target brightness value.

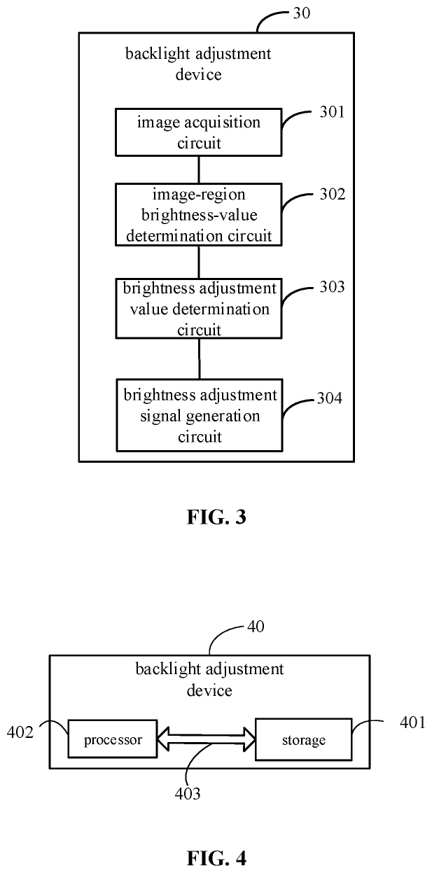

The embodiments of the present disclosure further provide a device for adjusting backlight. The device for adjusting backlight is applied to a Head-Up Display. As shown in FIG. 3, the device 30 for adjusting backlight includes: an image acquisition circuit 301, configured to acquire an image projected by the Head-Up Display onto a target region; an image-region brightness-value determination circuit 302, configured to divide the image into a plurality of image regions, and acquire a brightness value of each of the plurality of image regions; a brightness adjustment value determination circuit 303, configured to determine a brightness adjustment value of the each of the image regions according to the brightness value and a target brightness value of the each of the image regions; a brightness adjustment signal generation circuit 304, configured to generate, according to the brightness adjustment value of the each of the image regions, a brightness adjustment signal to be applied to one or more light sources of a backlight region corresponding to the each of the image regions in the Head-Up Display, such that the brightness value of each of the image regions reaches the target brightness value.

In an optional embodiment, the target brightness value is determined by using a preset brightness value as the target brightness value, or by using, as the target brightness value, an average brightness value calculated based on brightness values of all of the image regions, or by using a brightness value of one of the image regions as the target brightness value.

In an optional embodiment, the image of a preset color is a white image.

Corresponding to the foregoing method for adjusting backlight, the device for adjusting backlight provided by the present disclosure may improve a brightness uniformity of an image projected onto the target region, so that the brightness of the image is not affected by external light rays, and a display uniformity of the image is improved.

For the device embodiment, an implementation process of function and use of each of the circuits may be obtained by referring to an implementation process of corresponding steps in the foregoing method, and details are not described herein again.

The device embodiments described above are merely illustrative, wherein the circuits described as separate components may or may not be physically separate, are may be located in one place, or may be distributed over multiple network units; the above circuits may be combined into one circuit, or may be further split into a plurality of sub-circuits.

The device of this embodiment may also be implemented by means of software, or by software plus hardware programmed to perform the functions of the foregoing devices, and may of course be implemented by hardware. Based on such understanding, an essential part of the technical solution of the present disclosure or a part of the technical solution of the present disclosure contributing to the relevant art may be embodied in a form of a software product. Taking a software implementation as an example, a device in a logical sense is formed by reading a computer program included in a computer-readable storage medium into a memory by a processor included in a Head-Up Display of the device.

Optionally, the present disclosure also provides a device 40 for adjusting backlight. As shown in FIG. 4, the device 40 for adjusting backlight is applied to a Head-Up Display and includes a storage 401, a processor 402, and a bus 403, wherein the storage 401 stores a computer program executable on the processor 402, and the processor 402 is configured to read the computer program in the storage 401 to perform following steps: acquiring an image projected by the Head-Up Display onto a target region; dividing the image into a plurality of image regions, and acquiring a brightness value of each image region of the plurality of image regions; determining a brightness adjustment value of the image region according to the brightness value of the image region of the plurality of image regions and a target brightness value of the image region; according to the brightness adjustment value of the image region, generating a brightness adjustment signal to be applied to one or more light sources of a backlight region corresponding to the image region in the Head-Up Display, so as to adjust the brightness value of the image region.

Corresponding to the foregoing embodiment of the method for adjusting backlight, the device for adjusting backlight provided by the present disclosure may improve brightness uniformity of an image projected onto a target region so that the brightness of the image is not affected by external light, thereby improving display uniformity of the image.

Optionally, the present disclosure provides a computer readable storage medium having computer programs stored thereon, wherein when the computer programs are executed by a processor, the processor implements the method provided in the present disclosure. The processor may be a processor in the Head-Up Display.

Optionally, the present disclosure further provides a Head-Up Display. The Head-Up Display includes a display screen, an optical projection unit, and the device for adjusting backlight provided above in the present disclosure. The display screen includes a backlight source. The backlight source includes a plurality of backlight regions, and each of the plurality of backlight regions includes one or more light sources. The optical projection unit is configured to project an image displayed by the display screen to a target region. The device for adjusting backlight adjusts a brightness value of one or more light sources of each of the plurality of backlight regions according to the brightness adjustment signal.

Optionally, the display screen displays one image frame for every preset time period. The backlight source may be a direct-lit type backlight source, that is, the backlight source is located on a back side of the display, that is, the backlight source is located on a side opposite to a side at which the image displayed by the display screen is located. The back light source is not located at a side surface of the display. Through using the direct-lit type backlight source, each of the backlight regions is located on a back side of the display screen, and there is no need to provide a light guide plate. The backlight source may provide a more uniform backlight for the display screen, and a light-emitting direction of each of the one or more light sources in each backlight region directly faces the display screen. Each image region divided from the image displayed on the display screen may correspond to a backlight region in a one-to-one manner. Therefore, the brightness value of the image region may be adjusted more accurately.

Some embodiments of the present disclosure further provide a system for adjusting backlight including the Head-Up Display of any of the above embodiments, and a camera. The camera is configured to acquire an image projected to the target region, and transmit the acquired image projected to the target region to the Head-Up Display.

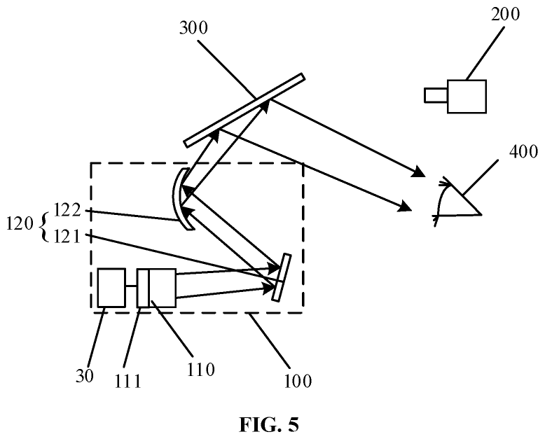

FIG. 5 shows a schematic structural diagram of a system for adjusting backlight. The system for adjusting backlight may be applied to a vehicle or in an aircraft. Referring to FIG. 5, the system includes a Head-Up Display 100 and a camera 200, the Head-Up Display 100 may be placed in the vehicle or in the aircraft, and the camera 200 may be disposed facing a windshield 300 of the vehicle or the aircraft, and the Head-Up Display 100 includes a display screen 110, an optical projection unit 120, and the device for adjusting backlight mentioned above in the present disclosure. The device for adjusting backlight 30 provided above is shown in FIG. 5 as an example of the device for adjusting backlight. The optical projection unit 120 includes, for example, a planar mirror 121 and a globoid mirror 122. A reflective surface of the planar mirror 121 faces a side of the display screen 110 displays an image, the display screen includes a backlight source 111, and the backlight source 111 includes a plurality of backlight regions. Each of the backlight regions includes one or more light sources.

Referring to FIG. 5, arrows in FIG. 5 indicate an optical path of light from the image displayed by the display screen, and the planar mirror 121 reflects, to the globoid mirror 122, the light from the image displayed by the display screen 110; and then the light from the image is reflected to a windshield 300 of the vehicle by the globoid mirror 122 so as to achieve a purpose of projecting the image displayed by display screen 110 to the windshield 300. The light from the image may be reflected by the windshield 300 to the driver's eyes, and the driver's eyes 400 may observe the image projected onto the windshield 300.

A frame of image may be displayed by the display screen 110 for every preset time period, and the optical projection unit 120 projects the image onto the windshield 300, and the camera 200 may capture the image, and the camera 200 may transmit the captured image to the device 30 for adjusting backlight in the Head-Up Display 100. The device 30 for adjusting backlight may divide the image into a plurality of image regions, determine the brightness value of each of the image regions, determine a brightness adjustment value of each of the image region according to a brightness value and a target brightness value of the each image region, and according to the brightness adjustment value of the each image region, generating a brightness adjustment signal to be applied to one or more light sources of the backlight region corresponding to the each image region, and adjusting light-emitting brightness of the one or more light sources of the backlight region according to the brightness adjustment signal, thereby making the brightness value of the each image region to achieve the target brightness value.

A structure of the system for adjusting backlight illustrated in FIG. 5 merely provides an exemplary embodiment, and the system for adjusting backlight of the present disclosure is not limited to the structure illustrated in FIG. 5.

The computer readable storage medium referred to herein may be any electronic, magnetic, optical, or other physical storage device that may contain or store information such as executable instructions, data, and so forth. For example, the computer readable storage medium may be a Radom Access Memory (RAM), a volatile memory, a nonvolatile memory, a flash memory, a storage drive (such as a hard disk drive), any type of storage disk (such as a Compact Disk, a Digital Video Disc, etc.), or a similar storage medium, or a combination thereof.

According to the above embodiments, the method for adjusting backlight, the device for adjusting backlight, and the system for adjusting backlight may adjust the brightness of the one or more light sources of the backlight region corresponding to the image region, so that the brightness of each image region may reach the target brightness value. When the Head-Up Display projects the displayed image onto the target region, brightness values of all image regions may be made uniform, and brightness uniformity of the image is not affected by external light, and display uniformity of the image projected to the target region is improved.

After one of ordinary skills in the art considers the specifications and practices disclosed herein, one of ordinary skills in the art may easily think of other technical solutions of the present disclosure; The present disclosure is intended to cover any variations, usages, or adaptations of the present disclosure, and the variations, usages, or adaptions follows general principles of the present disclosure and include common general knowledge or conventional technical means in the art that are not disclosed in the present disclosure. The specification and the embodiments are to be regarded to be illustrative only, a true scope and spirit of the present disclosure are pointed out by the following claims.

It should be understood that the disclosure is not limited to an exact structure described above and shown in the accompanying drawings, and may be subject to various modifications and changes without departing from the scope of the present disclosure. The scope of the present disclosure is defined only by the attached claims.

What is claimed is:

1. A method for adjusting backlight, the method being applied to a Head-Up Display and comprising:
acquiring an image projected by the Head-Up Display onto a target region;
dividing the image into a plurality of image regions, and acquiring a brightness value of each image region of the plurality of image regions;
determining a brightness adjustment value of the each image region according to the brightness value of the each image region of the plurality of image regions and a target brightness value of the each image region;
according to the brightness adjustment value of the each image region, generating a brightness adjustment signal to be applied to one or more light sources of a backlight region corresponding to the each image region in the Head-Up Display, so as to adjust brightness of the each image region to reach the target brightness value.

2. The method according to claim 1, wherein the target brightness value is determined by:
using a preset brightness value as the target brightness value; or
using, as the target brightness value, an average brightness value calculated based on brightness values of the plurality of image regions; or
using a brightness value of one image region of the plurality of image regions as the target brightness value.

3. The method according to claim 1, wherein the image is a white image, the plurality of image regions are M*N regions divided along a horizontal direction and a vertical direction of the image, and M and N are positive integers.

4. The method according to claim 2, wherein, in a case that the average brightness value calculated based on the brightness values of the plurality of image regions is used as the target brightness value, the average brightness value is a sum of the brightness values of the plurality of image regions divided by a total number of the plurality of image regions;
in a case that the brightness value of the one image region of the plurality of image regions is used as the target brightness value, the one image region is an image region located at a center position of the image.

5. A device for adjusting backlight, the device being applied to a Head-Up Display and comprising:
an image acquisition circuit, configured to acquire an image projected by the Head-Up Display onto a target region;
an image-region brightness-value determination circuit, configured to divide the image into a plurality of image regions, and acquire a brightness value of each image region of the plurality of image regions;
a brightness adjustment value determination circuit, configured to determine a brightness adjustment value of the each image region of the plurality of image regions according to the brightness value and a target brightness value of the each image region;
a brightness adjustment signal generation circuit, configured to generate, according to the brightness adjustment value of the each image region, a brightness adjustment signal to be applied to one or more light sources of a backlight region corresponding to the each image region in the Head-Up Display, such that the brightness value of the each image region reaches the target brightness value.

6. The device according to claim 5 , wherein the target brightness value is determined by:
using a preset brightness value as the target brightness value; or
using, as the target brightness value, an average brightness value calculated based on brightness values of the plurality of image regions; or
using a brightness value of one image region of the plurality of image regions as the target brightness value.

7. The device according to claim 5, wherein the image is a white image, the plurality of image regions are M*N regions divided along a horizontal direction and a vertical direction of the image, and M and N are positive integers.

8. The device according to claim 6, wherein, in a case that the average brightness value calculated based on the brightness values of the plurality of image regions is used as the target brightness value, the average brightness value is a sum of the brightness values of the plurality of image regions divided by a total number of the plurality of image regions;
in a case that the brightness value of one image region of the plurality of image regions is used as the target brightness value, the one image region is an image region located at a center position of the image.

9. A device for adjusting backlight, the device being applied to a Head-Up Display and comprising:
a processor;
a storage, coupled to the processor via a bus and comprising computer programs stored on the storage,
wherein, when the processor executes the computer programs, the processor implements the method for adjusting backlight according to claim 1.

10. A Head-Up Display, comprising:
a display screen, comprising a backlight source comprising a plurality of backlight regions, wherein each of the plurality of backlight regions comprises one or more light sources;
an optical projection unit, configured to project an image displayed by the display screen to a target region; and
the device for adjusting backlight according to claim 5,
wherein, the device for adjusting backlight adjusts brightness of the one or more light sources of each backlight region of the plurality of backlight regions according to the brightness adjustment signal.

11. The Head-Up Display according to claim 10, wherein the backlight source is a direct-lit type backlight source.

12. The Head-Up Display according to claim 10, wherein the display screen displays one frame of the image for every preset time period.

13. A system for adjusting backlight, comprising:
the Head-Up Display according to claim 10;
a camera, configured to face the target region and acquire the image projected to the target region and transmit the captured image to the Head-Up Display.

14. A non-transitory computer readable storage medium, comprising:
computer programs stored on the non-transitory computer readable storage medium, wherein when the computer programs are executed by a processor, the processor implements steps of the method according to claim 1.
